(19) United States
(12) Patent Application Publication
(10) Pub. No.: US 2014/0326536 A1
(43) Pub. Date: Nov. 6, 2014

(54) STRUCTURAL ACOUSTIC ATTENUATION PANEL

(71) Applicant: AIRCELLE, GONFREVILLE L'ORCHER (FR)

(72) Inventors: Guy Bernard VAUCHEL, HARFLEUR (FR); ERIC PILLON, BENARVILLE (FR); CHRISTOPHE MAHU, OCTEVILLE/MER (FR)

(73) Assignee: AIRCELLE, GONFREVILLE L'ORCHER (FR)

(21) Appl. No.: 14/243,326

(22) Filed: Apr. 2, 2014

Related U.S. Application Data
(63) Continuation of application No. PCT/FR2012/052226, filed on Oct. 2, 2012.

(30) Foreign Application Priority Data
Oct. 4, 2011 (FR) 11/58936

(51) Int. Cl. G10K 11/00

(52) U.S. Cl. CPC G10K 11/002
USPC 181/290

(57) ABSTRACT

An acoustic attenuation panel includes a resistive skin having acoustic holes, a solid skin and an acoustic structure. The acoustic structure includes a sound-absorbing material and is arranged between the resistive skin and the solid skin. In particular, the solid skin is structural and forms a transverse spacer between the solid skin and the resistive skin.

### CROSS-REFERENCE TO RELATED APPLICATIONS

This application is a continuation of International Application No. PCT/FR2012/052226, filed on Oct. 2, 2012, which claims the benefit of FR 11/58936, filed on Oct. 4, 2011. The disclosures of the above applications are incorporated herein by reference.

### FIELD

The present disclosure relates to an acoustic attenuation panel for turbojet engine nacelle, to elements of a nacelle equipped with such panels, and to the associated manufacturing methods.

### BACKGROUND

The statements in this section merely provide background information related to the present disclosure and may not constitute prior art.

The use of acoustic attenuation panels in the nacelles of turbojet engines to reduce noise emissions from turbojet engine, particularly by trapping the noise, is known from the state of the art.

These panels usually comprise a sound-absorbing material of hollow core structure-type (commonly called “honeycomb” structure) or porous material structure-type.

This sound-absorbing material is coated on its lower side, that is to say the side which is not in contact with the air flow inside the nacelle, with an inner skin impermeable to air, called “solid” which acts as an acoustic reflector.

It is further coated on its opposite upper side, that is to say, the side which is in contact with the air flow inside the nacelle, with a perforated outer skin permeable to air, called “resistive” or “acoustic”, which acts to dissipate the acoustic energy.

Such acoustic panels, beyond its primary function, must also have sufficient mechanical properties to transfer forces, particularly the aerodynamic forces, which they receive, to structural connections of the nacelle, otherwise the quality of the acoustic attenuation which it offers may deteriorate.

We know, in particular, acoustic attenuation panels in which stiffeners and/or spacers are implemented between the two skins of the concerned panels and/or between one of the skins and the acoustic structure to provide good structural resistance of panels.

These spacers and/or stiffeners are often distributed within the acoustic structure, along the panel.

An example of such a panel is known from the document FR 2 933 224 wherein the spacers are present within the acoustic structure and are, in addition, associated to mechanical fastening means passing through either side of the acoustic structure in order to connect the two skins of the panel.

Even if the different forms of the panels described in the document FR 2 933 224 reduce the docking defects of the acoustic structures on the inner and outer skins of the panel, the presence of spacers nonetheless increases the risk of tolerance and mismatch defects of the constituent elements of the panel, penalizing the acoustic qualities of the latter.

Such defects are even more prevalent when the acoustic structure is complex, composed of one or more honeycomb core blocks being stacked and/or juxtaposed.

The presence of spacers within the acoustic structure affects the effective acoustic surface of the panels as well as the mass of the latter.

This applies to any mechanical fastening means located within the acoustic structure, along the latter.

Manufacturing such panels is, moreover, burdensome, which increases the production costs and the associated maintenance costs.

Document FR 2 933 224 discloses, in addition, a panel in which a skin, which is not in contact with the acoustic structure, is self-stiffened to provide a good structural resistance of the panels.

Such a solution does not deprive the panel from the use of stiffeners and/or spacers between the two skins, in order to provide the good structural resistance of the panel as a whole.

If stiffeners are applied inside the structure, the acoustic surface is also reduced consequently.

### SUMMARY

The present disclosure provides an acoustic attenuation panel whereof the effective acoustic surface is provided while observing the structural properties to be met in such a panel.

It is also to provide an acoustic attenuation panel characterized by weight reduction, which is easily and rapidly manufactured and repaired if necessary.

The present disclosure also provides an acoustic attenuation panel which makes it possible to absorb tolerances of stacking of complex acoustic structures.

In one form, the present disclosure provides an acoustic attenuation panel which offers anti-corrosion protection to the acoustic structure which constitutes it, in a simple and effective manner.

To this end, the present disclosure provides an acoustic attenuation panel comprising the following main elements:
a resistive skin having acoustic holes,
a solid skin,
an acoustic structure comprising a sound-absorbing material and arranged between the resistive skin and the solid skin,
characterized in that the solid skin is structural and is configured in order to form at least one transverse spacer between the solid skin and the resistive skin of the acoustic attenuation panel.

By spacer, we mean an element adapted to:
provide a connection between the two skins,
fulfill a reinforcing function in the acoustic attenuation panel, or
maintain a constant distance between the two skins of the panel.

The present disclosure removes any spacer or reinforcement embedded in the acoustic structure, which contributes to an increase of the effective acoustic surface of the panel in comparison to an acoustic attenuation panel of the prior art having the same dimensions.

Furthermore, the present disclosure provides the acoustic structure with a skin whereof the structural properties are sufficient to eliminate any use of structuring acoustic structure.

In forms which do not involve either gluing the constituent elements of the acoustic structure or expanding foam, the acoustic holes are unlikely to risk clogging. Only a proper peripheral bonding of the resistive skin on the hull remains to be checked with requirement levels lower than those stated in the prior art, since the resistive skin is not considered structural, hence a reduction in nonconformities.

Advantageously, the acoustic panel of the present disclosure makes it easier to mount the acoustic structure and the resistive skin on the solid skin, which provides high industrial feasibility, namely fast execution, reduction of production costs as the panel assembling steps are reduced with respect to the prior art, and also easy maintenance and repair as the assembly of the concerned panel is simplified.

According to other features of the present disclosure, the acoustic attenuation panel of the present disclosure includes one or more of the following optional features, considered individually or in all possible combinations:
the solid skin is configured to form a transverse spacer between the solid skin and the resistive skin on either side of the acoustic structure, forming a receiving shell in the concavity of which the acoustic structure is housed;
the solid skin forms an imprint of the acoustic structure which it receives;
the solid skin comprises at least one return along at least a portion of the periphery of the acoustic structure towards the resistive skin;
this return further extends on the resistive skin;
the solid skin is monolithic;
the solid skin integrates reinforcements;
the solid skin is formed at least in part by a double wall in which a reinforcing structure is arranged;
the internal surface of the skin, facing the acoustic surface, has a rough aspect;
the acoustic structure is housed in the concavity of the shell by embedding;
the acoustic structure is housed in the concavity of the shell, by compression, using elastic means and/or mechanical fastening means;
at least one part of the elastic means comprises means of anchoring the acoustic structure;
these anchoring means comprise a corrugated acoustic structure and/or an acoustic structure having teeth on either or both of these sides;
at least one part of the elastic means comprises draining means at the interface between the acoustic structure and the solid skin, adapted to be compressed in thickness;
at least one part of the elastic means includes dampers extending from the surface of the acoustic structure facing a bearing surface of the solid skin and/or of the resistive skin;
the dampers are in the form of spot bulbs of elastic material brought onto the surface of the acoustic structure;
at least one part of the mechanical fastening means is adapted to secure the solid skin and the resistive skin at the interface of the two skins.

According to a second aspect, the present disclosure relates to a nacelle element comprising an acoustic panel according to the present disclosure.

### DRAWINGS

The present disclosure will be better understood upon reading the non-limiting description which follows, with reference to the figures appended herein, in which:

FIGS. 1a to 1d are sectional views of a method of manufacturing a panel according to a first form of the present disclosure;

FIGS. 2a to 2b, 3a to 3c, 4a, 5a, 6a, 6c, 7a to 7b, 8 are sectional views of other forms of the panel according to the present disclosure;

FIGS. 4b, 5b, 6b are enlarged views respectively of areas A, B, C of FIGS. 4a, 5a, 6a; and

FIG. 9 is a sectional view of a solid skin of a panel according to another form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

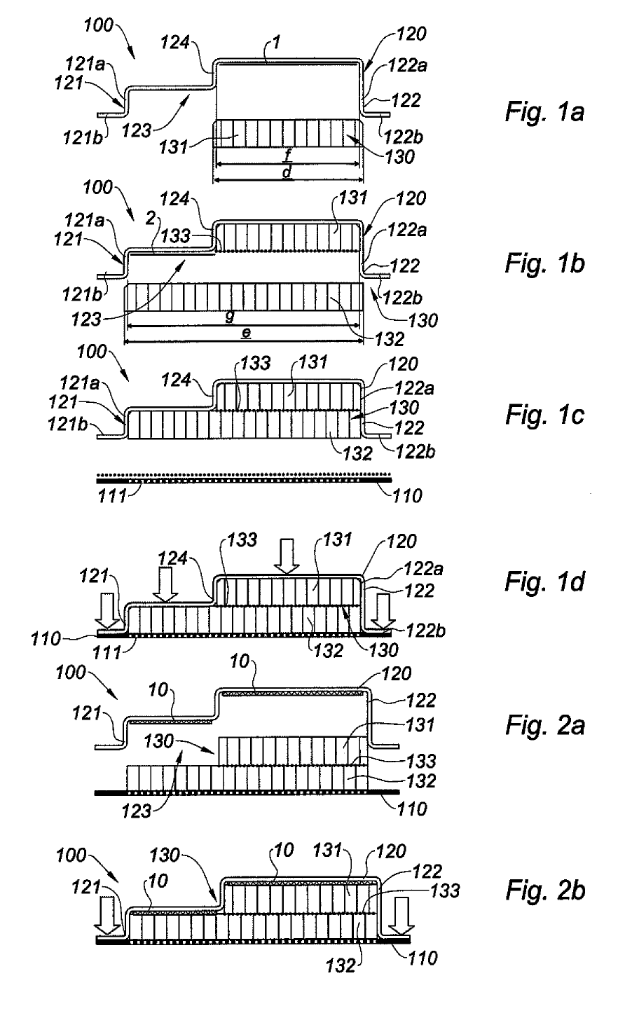

Referring to FIGS. 1a to 1d, an acoustic attenuation panel 100 comprises:
a resistive skin 110 having acoustic holes,
a solid skin 120,
an acoustic structure 130 comprising a sound-absorbing material and
disposed between the resistive skin 110 and the solid skin 120.

The acoustic structure 130 may comprise a honeycomb structure formed by honeycomb core cells or NIDA, as illustrated in these figures.

In an alternative form, it may comprise a porous material having sound-absorbing properties to replace the NIDA structure.

This porous material has an open structure, that is to say, open cells capable of absorbing the energy of the acoustic waves.

Mention may be made, for example, of a foam-type material or a material in expanded form.

This acoustic structure 130 may be of distributed acoustic-type or not.

It may comprise a single or multiple resonator, may be formed of several honeycomb/porous layers or not, separated or not by septa.

In the non-limiting example shown in FIGS. 1a to 1d, the acoustic structure 130 is formed of a distributed acoustic structure comprising a first and a second layer 131, 132 of superimposed honeycomb cells separated by a septum 133, the cells of the two layers 131, 132 being identical or not.

The resistive skin 110 in contact with the streamline flow is, in turn, perforated with multiple holes 111, positioned according to a defined arrangement depending on the desired acoustic attenuation.

According to the present disclosure, the solid skin 120, which is not in contact with the air flow, is structural and configured to form at least one transverse spacer 121 between the solid skin 120 and the resistive skin 110 of the acoustic attenuation panel 100.

In one form, the solid skin 120 is configured to form a transverse spacer 121, 122 between the solid skin 120 and the resistive skin 110 on either side of the acoustic structure 130, thereby forming a shell 123 for receiving the acoustic structure 130.

More particularly, the two spacers are formed by two set interface returns 121, 122 on either side of the acoustic structure 130, along at least in part the periphery of the acoustic structure 130 towards the resistive skin 110 with which it is in point contact or not.

In the illustrated alternative form, these returns 121,122 have each an inverted L-shape, whereof one of the branches 121a, 122a forms an interface with the acoustic structure 130 and extends by the other branch 122b, 123b which forms the interface with the resistive skin 110.

Thus, the acoustic structure 130 is held in place by the returns 121,122 of the shell 123.

Furthermore, as illustrated in FIGS. 1a to 1d, the shell 123 forms an imprint of the acoustic structure 130 that it houses and more particularly, the concavity of the shell 123 is shaped and sized to receive the associated acoustic structure 130.

Thus, in this non-limiting example, the bottom of the shell 123 comprises an internal return 124, towards the acoustic structure 130, defining two levels of depth for the shell 123 corresponding each respectively to the first and second layers 131, 132 of the corresponding acoustic structure 130.

Advantageously, such a shell 123 makes it possible to absorb the tolerances of stacking up the different layers of the complex acoustic structures 130.

Furthermore, in an alternative form, this solid shell 123 is monolithic.

It has structural properties and forms a rigid structural layer adapted to receive all the forces to which the panel 100 is subjected and to channel these forces to other structural connections of the nacelle element of which they are components, without deforming the acoustic structure 130 or the resistive skin 110.

The acoustic structure 130 and the resistive skin 110 are, in turn, not structuring.

The solid skin 120 or shell 123 is, therefore, formed by a thermosetting material of the composite type for example, by a thermoplastic material which may be reinforced or not, or by a metallic material.

Furthermore, the shell 123 may have an inner surface, in the concavity thereof, which is smooth or rough depending upon the material in which it is formed.

In an alternative form, we may provide a surface treatment of the shell 123 before installing the acoustic structure 130 in the concavity thereof.

For a shell 123 made from a composite material, a delaminating fabric may have to be removed when the acoustic structure 130 is installed, to obtain a raw inner surface for binding said structure 130.

In other alternative forms, we may consider any other mechanical method such as sandblasting, grinding or a method of treating a chemical surface by an agent, etching the inner surface of the shell 123.

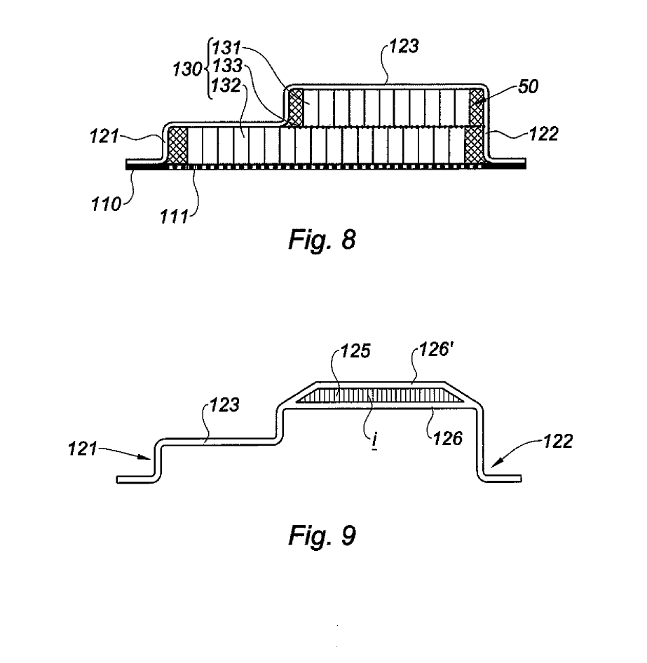

In another form illustrated in FIG. 9, this solid shell 123 is totally or partially self-stiffened.

It incorporates reinforcements over its entire structure or a portion thereof.

More particularly, it may be formed at least in part by a double wall 126, 126′ forming a gap “i” wherein a reinforcing structure 125 is installed.

The formed gap “i” extends over a portion of the outer side of the shell portion 123 forming the bottom, opposite the concavity of the shell 123.

In a non-limiting example, this reinforcing structure 125 may be a honeycomb core structure.

An alternative form may also provide for reinforcing, in a similar way, the whole set of one or more returns 121, 122, 124 of the shell 123, or a portion thereof.

The acoustic structure 123 is housed in the concavity of the shell 123, by compression, using:
elastic means and/or
mechanical fastening means and/or
by embedding and simple contact.

In this context, a first manufacturing method of the panel illustrated in the FIGS. 1a to 1d is as follows.

In this alternative form, the acoustic structure 130 is installed into the receiving shell 120, by embedding either via a distortion of the acoustic structure 130 or without distortion of the acoustic structure 130 in case of adjusted embedding without clearance between the shell 123 and the acoustic structure 130.

As illustrated in FIGS. 1a and 1b, in the context of embedding by distortion, the respective length “d”, “e” of the first 131 and second 132 layers of the acoustic structure 130 is greater than the length “f”, “g” of the housing of the shell 123 made for receiving the latter, respectively, in the concavity thereof, in order to embed and block the different layers of the acoustic structure 130 in the shell 123.

With reference to FIG. 1a, the acoustic structure 130 can be in simple contact with the shell 123, or, if necessary, in contact through a mechanical fastening means of the glue deposit-type.

The glue used can be any type of glue known to those skilled in the art.

More particularly, at least one fold 1 of glue can be applied on the surface of the shell 123 bottom and/or the surface of the first layer 131 of the acoustic structure 130 in contact with this shell 123 bottom may be pre-glued and/or cross-linked.

With reference to FIG. 1b, the installation of a septum 133, where appropriate, may be performed by any suitable means.

In one form, it can be performed by a pre-gluing of the surface of the first layer 131 of the acoustic structure 130 in contact with this septum 133, followed by cross-linking.

The installation of the second layer 132 of the acoustic structure 130 can be performed similarly to the first layer 131.

Thus, at least one fold of glue 2 may be applied on the surface of the shell 123 bottom, which remained free after the application of the first layer 131, where appropriate, and/or the surface of the second layer 132 of the acoustic structure 130 in contact with this bottom and the septum 133 where appropriate or the first acoustic layer 131.

For the installation of the resistive skin 110 illustrated in FIG. 1c, a glue deposit can be performed on the surface of the second acoustic layer 132 facing the skin 110, in combination or not with a glue deposit on the surface of the returns 121b 122b of the shell 123 facing said resistive skin 110.

In an alternative form, we may provide for a glue deposit onto the surface of the resistive skin 110.

More generally, gluing is performed in such a way that the acoustic holes are not clogged, so as to avoid any limitation of sound absorption.

Referring to FIG. 1d, a strain is subsequently exerted on the entire panel 100 and, more particularly, on the outer surface of the shell 123, in order to perform all the gluing operations.

The strain can be exerted by any known device and can be gaseous or mechanical.

Moreover, it can be locally exerted on the returns 121, 122 being at the interface with the resistive skin 110 only or on the entire shell 123.

Further, these gluing operations carried out under strain can be performed, if necessary, using a hot process conducted in a furnace or a cold process.

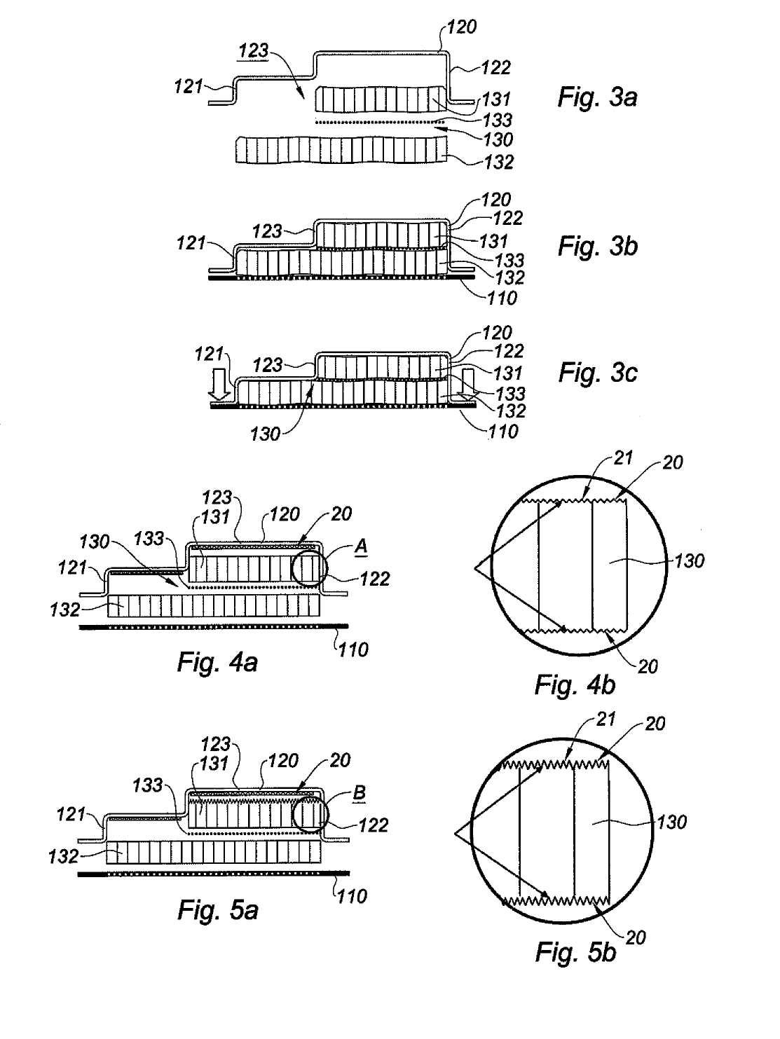

Another form is illustrated in FIGS. 2a and 2b.

In this context, the acoustic assembly formed by the acoustic structure 130 and the resistive skin 110 may be preassembled, particularly but not exclusively as described above in connection with FIGS. 1a to 1d, before any installation of the acoustic structure 130 in the shell 123.

Such an assembly is subsequently installed by embedding into the shell 123.

In an alternative form, we can provide that the acoustic structure and the shell have complementary shapes and dimensions enabling an adjusted embedding, without clearance, of the acoustic structure 130 in the concavity of the shell 123, without distortion of the acoustic structure 130.

Moreover, prior to arranging of the acoustic assembly in the shell 123, the draining means 10 of the acoustic panel 100 are installed in the bottom of the shell 123, owing to the presence of a clearance between the acoustic assembly and the shell 123 bottom.

These draining means 10 also have elastic properties.

They are able to be compressed in terms of thickness, thus forming an elastic mat for the acoustic structure 130.

More particularly, these draining means 10 may comprise, in a non-limiting way, one or more perforated rebates, one or more embossed lattices or one or more fibrous sets comprised of entangled fibers, such as a felt.

The draining means 10 of the acoustic panel 100 being used in an environment with a temperature lower than 100° C., they may be made up from ordinary commercial low cost materials.

A felt, particularly, may be formed of a material selected from felts integrating, according to the need of the person skilled in the art, at least: the porosity of the felt, the tortuosity of the fibers, the aspect ratio, the average size of the fibers, the entanglement rate, which makes it possible to obtain a good elasticity in the felt thickness.

This felt must have properties of resistance to water and to all kinds of fluids encountered in aeronautics.

Typically, the thickness of the felt is compatible with the desired compression value.

The draining means 10 are placed in simple contact with the bottom of the shell 123 and the acoustic structure 130.

However, other types of elastic or mechanical fastening can be envisaged.

The acoustic assembly and the draining means 10 being placed in the shell 123, a strain is exerted on the outer surface of the shell, similarly to the form of FIG. 1d, in order to perform all the gluing operations.

The presence of the draining means 10 enables a contact under strain of the acoustic assembly on the shell 123.

A high gluing quality of the acoustic structure 130 on the skins of the panel 100 is thus provided.

Advantageously, the drainage membranes on the acoustic structure 130 are also eliminated, due to the presence of the draining means 10 in the shell 123 bottom.

Three other forms are illustrated in FIGS. 3a to 5b.

In these forms, the acoustic structure 130 is carried out, and embedded, with clearance or without clearance, in the shell 123 by simple contact.

More particularly, no glue deposit is carried out between the acoustic structure 130 and the shell 123, or between the different constituent elements of the acoustic structure 130, namely between the different acoustic layers 131, 132 and between the different acoustic layers 131, 132 and the septa 133, if applicable.

Gluing is replaced by anchoring means 20 by simple contact of the acoustic structure 130 in the shell 123.

The absence of gluing helps reducing the risk of blocking the perforations of the resistive skin 110 and the septa 133, if applicable.

Furthermore, the operating conditions of the acoustic panels 100 manufacture are simplified by eliminating controlled atmosphere environments, protective clothing, and by reducing the manufacturing steps, in the absence of glue cross-linking steps.

More specifically, with reference to FIGS. 3a to 3c, a first alternative form of the anchoring means 20 comprises an acoustic structure whereof the different acoustic layers 131, 132 are corrugated.

Each corrugated acoustic structure 130 must meet at least the following feature: the distortion load of the acoustic structure 130 must be lower than the stiffness of the corresponding acoustic panel 100, while providing effective wedging of the acoustic structure 130 in the panel shell 123.

The corrugation characteristics, namely in particular the length, the height, the deflection, the amplitude, the configuration of the corrugation are defined depending on the desired shaping strength, in particular by tests, experiments and/or calculations.

In another form, the deflection and the height of the acoustic structure 130 are defined so that a residual deformation of the acoustic structure 130 remains once the resistive skin 110 is applied on said structure 130.

An improved docking of the acoustic structure 130 between the resistive skin 110 and the shell 123 is therefore provided.

The panel mounting is as follows.

We set up successively the first corrugated acoustic layer 131, the septum 133 if applicable, the second corrugated acoustic layer 132 (FIG. 3a) and the resistive skin 110 within and against the shell 123 (FIG. 3b).

As illustrated in FIG. 3c, a strain (illustrated by arrows) is subsequently exerted either on the reinforcements 121, 122 of the shell 123 at the interface with the resistive skin 110 or on the entire shell 123, similarly to the other previously described forms.

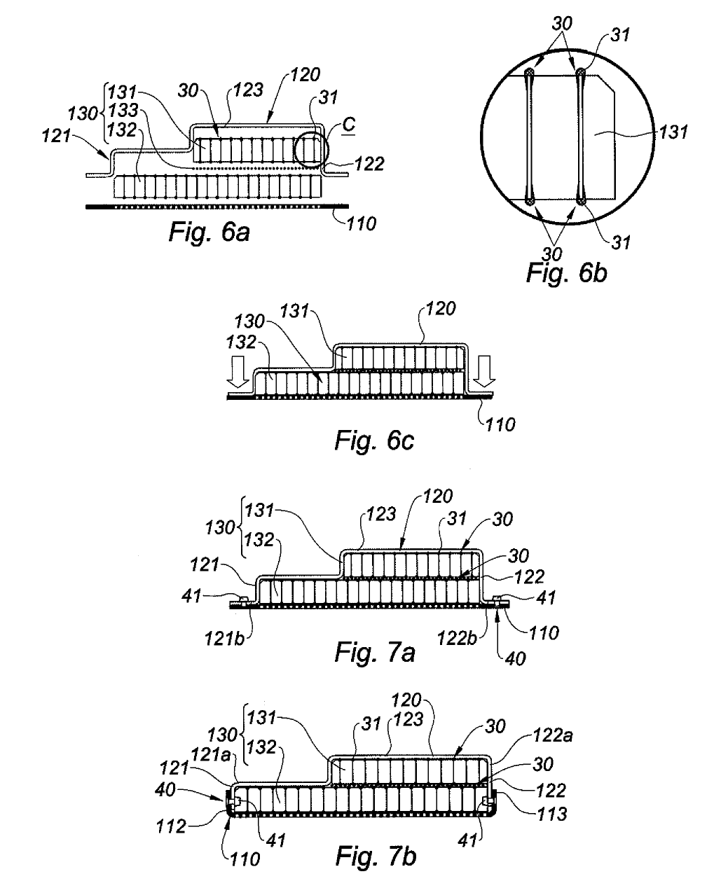

Referring to FIGS. 4a and 4b, a second alternative form of the anchoring means 20 comprises an acoustic structure wherein at least the side of the acoustic structure facing the shell 123 includes teeth 21, in order to improve the anchoring of the acoustic structure 130 on this shell 123.

These teeth 21 may be arranged on the entire side or only on one or more portions thereof.

We may also envisage that the walls of the acoustic layers and in particular of the honeycomb core cells facing a septum 133 and/or the resistive skin 110 are also provided with teeth.

The teeth 21 are more or less marked depending on the choice of the person skilled in the art and on the desired adhesion of the acoustic structure 130 on the opposite skins 110, 120.

In another form, the teeth 21 are shaped so as to minimize their contact surface with their bearing surface, namely, a skin 120, 110, a septum 133 or other element.

In FIGS. 4a to 4b and 5a to 5b , we observe two alternative forms of the same form of toothed acoustic structure 21, the teeth of the form of FIGS. 56a to 5b being finer and more acute than those of the form of FIGS. 4a to 4b.

The panel 100 mounting of the forms 4a and 5a is identical to that of FIGS. 3a to 3c.

It should be noted that the strain exerted on the shell 123 puts the acoustic structure 130 under elastic stress by distortion of the teeth 21, or even the cells in the context of honeycomb acoustic structure 130.

Furthermore, as shown in FIG. 4a, we may, in addition, arrange draining means 10 at the bottom of the shell 123, prior to any installation of the toothed acoustic structure 130.

Such a possibility is also possible for the corrugated acoustic structures 130.

These draining means 10 may be similar to those described in connection with FIGS. 2a to 2b.

In this context, the walls of the acoustic layers 131, 132 facing the draining means 10 may have teeth 21.

According to another form illustrated in FIGS. 6a to 6c, the acoustic structure 130 comprises at least one surface facing the inner surface of the shell 123 bottom equipped with elastic means 30.

These elastic means 30 may be arranged on the entire surface, only on one or more portions of the latter or locally along the latter.

It is also envisaged that the walls of the acoustic layers 131, 132 and in particular of the honeycomb core cells facing a septum 133 and/or the resistive skin 110 are also equipped with elastic means.

These elastic means have a low amplitude elasticity which provides a contact of the acoustic structure 130 under a mild stress at its interface with the shell 123 and, where appropriate, a septum 133 or the resistive skin 110.

These elastic means 30 may comprise a deposit of an elastic material such as rubber, as illustrated in FIGS. 6a and 6b, or any other elastic means, adapted, applied or formed on the corresponding sides of the layers 131, 132 of the acoustic structure 130.

The number, shape and arrangement of said elastic means are adapted by the person skilled in the art, particularly to promote a uniform contact of the acoustic structure 130 on these different supports.

In the example illustrated in FIGS. 6a to 6c, each acoustic layer comprises, on each of these sides, point-shaped deposits or elastic rubber bulbs 31 on each of the honeycomb core cells.

This deposit can be achieved by dip coating the acoustic structure 130 prior to shaping the latter.

It can be achieved, moreover, by cross-linking or any other suitable method enabling to apply an elastic bulb at the end of honeycomb cells.

In one form, each deposit of elastic material is adapted to allow crushing of the acoustic structure 130, under a strain of a few tenths of mm.

Such deposits provide advantageously a consistent contact surface between the acoustic structure 130 and the concerned support, in particular the acoustic skin 110, which results in isolation of the honeycomb cells, if applicable, and provides an improved acoustic performance by removing any leakage between each cell and the acoustic skin 110.

Moreover, advantageously, such deposits form a protection against corrosion of the acoustic structure 130 made up from metallic material, for example, by providing sealing to the sides of the latter on which deposits are present.

Mounting of such an acoustic panel 100 is identical to that of FIGS. 3a to 3c.

It should be outlined that the strain exerted on the shell 123 puts under elastic stress the acoustic structure 130 by distortion of the bulbs 31, or even the cells in the context of the honeycomb acoustic structure.

In this context, the thickness of the acoustic structure 130 added to that of the elastic bulbs 31 must be higher than the depth of the shell 123 receiving the structure 130.

An alternative form may provide for several types of elastic elements on a same side of the acoustic structure 130 or on both sides of the acoustic structure 130.

Another form is illustrated, by two alternatives, in FIGS. 7a and 7b.

The acoustic structure 130 is held in contact on the resistive skin 110 and within the shell 123, by compression, using mechanical fastening means 40.

In this form, the fastening means are adapted to fasten, together, the shell 123 and the resistive skin 110, at the lateral returns 121, 122 of the shell 123.

Advantageously, we obtain an acoustic attenuation panel 100 whereof the effective acoustic area is provided by bringing the fastening connections on the shell 123/resistive skin 110 interfaces. We avoid any clogging of the acoustic holes of the acoustic structure 130 by the fastening means.

By eliminating the gluing operations of the component elements of the panel, we facilitate, moreover, repairs as well as maintenance of the panels 100 and the replacement of component pieces thereof, if necessary.

According to an alternative form shown in FIG. 7a, the mechanical fastening means 40 comprise rivets 41 or bolts, fastening the resistive skin 110 to the opposite branch 121a, 122b or 121b, 122b of the return 121, 122, of the interface of the shell 123.

These rivets 41 cooperate with orifices arranged on the returns and the resistive skin 110 adapted to be crossed by the rivets 41.

According to the alternative form shown in FIG. 7b, a peripheral return 112, 113 of the resistive skin 110 can be provided toward the acoustic structure 130, extending opposite a return 121a, 122a of the shell 123 defining the interface of the shell 123 and of the acoustic structure 130, on the thickness of the acoustic structure 130.

The peripheral return 112, 113 is thus perpendicular to the base plane of the resistive skin 110.

The resistive skin 110 and the shell 123 are therefore fastened through the reinforcements thereof placed on a lateral opposite side of a layer of the acoustic structure.

In one form, the mechanical fastening means are made up from a material which is not necessarily structural according to the loads and temperature, it may be made of synthetic material or aluminum-based material.

Furthermore, as illustrated in each of the alternative forms, we can associate elastic means 30 with the mechanical fastening means 40.

We may thus provide, in a non-limiting way, for using an acoustic structure 130 equipped with elastic bulbs 31 on either or both of these sides, as described in connection with FIGS. 6a to 6c.

We can also provide for the installation of elastic means of the felt type or otherwise, between the bottom of the shell 123 and the acoustic structure 130.

Another alternative form is shown in FIG. 8.

In this alternative form, the mechanical fastening means comprise a gluing by expanding foam of the acoustic structure 130 within the shell 123.

In this alternative form, the acoustic assembly, namely the acoustic structure 130 and the resistive skin 110, is formed by any suitable means, prior to the installation of the acoustic structure 130 within the receiving sheath formed by the shell 123.

More particularly, the different acoustic layers 131, 132 and the septa 133 where appropriate, are pre-glued on the resistive skin 110.

Thereafter, a deposit of expanding foam 50 is performed on the periphery of the acoustic structure 130.

The formed acoustic assembly is therefore placed in the concavity of the shell 123.

It should be noted that, in this context, the dimensions of the acoustic structure 130 have been adapted to provide a clearance between the reinforcements 121, 122 of the shell 123 and the acoustic structure 130, this clearance being filled by the expanding foam 50.

The panel is subsequently polymerized by any suitable means. During polymerization, the foam 50 comes to extend against the returns of the shell 123 and within the surrounding honeycomb cells if the acoustic structure is of the honeycomb core type.

At this stage, we obtain an acoustic panel wherein the resistive skin 110 is glued to the shell and to the acoustic structure.

This alternative form is available but it has some disadvantages with respect to the other forms of the present disclosure.

Indeed, it affects the mass of the panel 100 and may reduce the effective acoustic surface compared to the other available forms.

Although the present disclosure has been described with specific forms, it is obvious that it is in no way limited to these forms and that it comprises all technical equivalents of the described means as well as the combinations thereof if the latter are encompassed within the scope of the present disclosure.

Thus, one may consider a panel 100 whereof the form is a combination of the different forms described in connection with the illustrated figures.

What is claimed is:

1. An acoustic attenuation panel comprising:
a resistive skin having acoustic holes;
a solid skin; and
an acoustic structure comprising a sound-absorbing material, said acoustic structure being arranged between the resistive skin and the solid skin,
wherein the solid skin is structural and is configured to form at least one transverse spacer between the solid skin and the resistive skin of the acoustic attenuation panel.

2. The acoustic attenuation panel according to claim 1, wherein the solid skin is configured to form said at least one transverse spacer on either side of the acoustic structure, said solid skin forming a receiving shell in a concavity of which the acoustic structure is housed.

3. The acoustic attenuation panel according to claim 1, wherein the solid skin forms an imprint of the acoustic structure which said solid skin receives.

4. The acoustic attenuation panel according to claim 1, wherein the solid skin comprises at least one return along at least one portion of a periphery of the acoustic structure towards the resistive skin.

5. The acoustic attenuation panel according to claim 4, wherein said at least one return further extends on the resistive skin.

6. The acoustic attenuation panel according to claim 1, wherein the solid skin is monolithic.

7. The acoustic attenuation panel according to claim 1, wherein the solid skin integrates reinforcements.

8. The acoustic attenuation panel according to claim 7, wherein the solid skin is formed at least in part by a double wall wherein a reinforcing structure is arranged.

9. The acoustic attenuation panel according to claim 1, wherein an inner surface of the solid skin, facing the acoustic surface, has a rough aspect.

10. The acoustic attenuation panel according to claim 2, wherein the acoustic structure is housed in the concavity of the receiving shell by embedding.

11. The acoustic attenuation panel according to claim 2, wherein the acoustic structure is housed in the concavity of the shell, by compression, or by using at least one of elastic means and mechanical fastening means.

12. The acoustic attenuation panel according to claim 11, wherein at least one portion of the elastic means comprises anchoring means of the acoustic structure.

13. The acoustic attenuation panel according to claim 12, wherein said anchoring means comprise at least one of a corrugated acoustic structure and an acoustic structure having teeth on either or both sides of said acoustic structure.

14. The acoustic attenuation panel according to claim 12, wherein said at least one portion of the elastic means comprises draining means at an interface between the acoustic structure and the solid skin, capable of being compressed in thickness.

15. The acoustic attenuation panel according to claim 12, wherein said at least one portion of the elastic means includes dampers in extension of a surface of the acoustic structure facing a bearing surface of the solid skin and/or the resistive skin.

16. The acoustic attenuation panel according to claim 15, wherein the dampers are in a form of spot bulbs made up from elastic material applied on the surface of the acoustic structure.

17. The acoustic attenuation panel according to claim 11, wherein at least one portion of the mechanical fastening means is adapted to fasten the solid skin and the resistive skin at an interface of the solid and resistive skins.

18. A nacelle element comprising an acoustic attenuation panel according to claim 1.
